(19) United States
(12) Patent Application Publication
(10) Pub. No.: US 2008/0081219 A1
(43) Pub. Date: Apr. 3, 2008

(54) Magnetoresistance effect element and method of producing the same

(75) Inventors: Kouji Hirano, Odawara (JP); Mitsuru Otagiri, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/800,566

(22) Filed: May 7, 2007

(30) Foreign Application Priority Data
Sep. 29, 2006 (JP) 2006-266263

(51) Int. Cl. G11B 5/39; G11B 5/127; G11B 5/33

(52) U.S. Cl. 428/811; 360/313

(57) ABSTRACT

The magnetoresistance effect element includes: a magnetization fixing layer; a barrier layer formed on the magnetization fixing layer; and a free layer formed on the barrier layer. The method of producing the magnetoresistance effect element comprises the steps of: forming the magnetization fixing layer on a substrate; forming a metal film as the barrier layer, wherein one part of the metal film on the magnetization fixing layer side is in an amorphous state or a refined crystal state and the other part thereof on the other side is in a crystal state; natural-oxidizing the metal film in an oxidizing atmosphere; forming the free layer on the oxidized metal layer.

### BACKGROUND OF THE INVENTION

The present invention relates to a magnetoresistance effect element, which is used for a read-element and a magnetic memory (MRAM) of a magnetic disk drive unit, and a method of producing the magnetoresistance effect element.

A conventional magnetic disk drive unit including a magnetoresistance effect element is disclosed in Japanese Patent Kokai Gazette No. 2005-340715. The magnetic disk drive unit is shown in FIG. 4. A TMR element 10B is used as a magnetoresistance effect element. In the TMR element 10B, a barrier layer 8, an antiferromagnetic layer 5, a magnetization fixing layer 4, a tunnel barrier layer (barrier layer) 3, a magnetization free layer (free layer) 2 and a top coat layer 1 are layered in this order.

The tunnel barrier layer (barrier layer) 3 magnetically insulates the magnetization free layer (free layer) 2 from the magnetization fixing layer 4 and applies a tunnel electric current, which corresponds to a magnetization direction of the magnetization free layer 2. The barrier layer 3 is made of an insulating material, e.g., aluminum oxide, magnesium oxide. The barrier layer 3 is formed by oxidizing a sputtered metal film (see paragraph 0016 of the patent, kokai gazette).

A conventional method of producing a magnetoresistance effect element, which is used for a read-element of a magnetic disk drive unit, is shown in FIGS. 5A-5C.

In FIG. 5A, firstly, a base layer 14 is formed on a wafer substrate 12. Next, an antiferromagnetic layer 16, a first magnetization fixing layer 18a, a ruthenium (Ru) layer 18b and a second magnetization fixing layer 18c are formed on the base layer 14 in this order. The first magnetization fixing layer 18a, the ruthenium (Ru) layer 18b and the second magnetization fixing layer 18c are called as a pinned layer. The first magnetization fixing layer 18a and the second magnetization fixing layer 18c are made of a ferromagnetic material, e.g., Co—Fe alloy.

In FIG. 5B, a metal film 20, e.g., aluminum film, is formed on the second magnetization fixing layer 18c by sputtering. A thickness of the metal film 20 is about 5 Å.

Next, the wafer substrate 12 is put into an oxygen atmosphere chamber so as to oxidize the metal film 20, so that the metal film 20 becomes aluminum oxide (Al-Oxide or AlO).

Note that, in the following description, oxidizing a substance in an oxygen atmosphere is called “natural oxidization”.

The metal film 20 made of the Al-Oxide acts as the barrier layer (tunnel barrier layer).

By oxidizing the metal film 20, volume of the metal film is increased so that the metal film 20 is made thicker. For example, when the initial thickness of the metal film 20 is about 5 Å, the thickness of the oxidized metal film 20 made of Al-Oxide will be about 10 Å.

In FIG. 5C, a free layer 22 is formed on the barrier layer (oxidized metal film), and a top coat layer 24 is formed on the free layer 22.

Namely, the magnetoresistance effect element is constituted by the base layer 14, the antiferromagnetic layer 16, the first magnetization fixing layer 18a, the ruthenium (Ru) layer 18b, the second magnetization fixing layer 18c, the barrier layer 20, the free layer 22 and the top coat layer 24.

In the conventional production method, a part of the second magnetization fixing layer 18c will be oxidized together with the metal film 20 when the metal film 20 is natural-oxidized.

If the second magnetization fixing layer 18c is oxidized, characteristics of the second magnetization fixing layer 18c, e.g., MR ratio, is made worse, so that reading characteristics of the magnetoresistance effect element (read-element) are made worse.

### SUMMARY OF THE INVENTION

The present invention was conceived to solve the above described problems.

An object of the present invention is to provide a magnetoresistance effect element, which is capable of restraining oxidization of a magnetization fixing layer formed under a barrier layer when a metal film acting as the barrier layer is natural-oxidized so as to prevent deterioration of magnetic characteristics of the magnetization fixing layer and stabilize reading characteristics.

Another object is to provide a method of producing said magnetoresistance effect element.

To achieve the objects, the present invention has following structures.

The inventors of the present invention found a correlation between progress of natural oxidization of a barrier layer (metal film) in a layering direction from a surface thereof and a crystal condition of the barrier layer (metal film). Further, they have studied and invented a technology for oxidizing the barrier layer without oxidizing the magnetization fixing layer on the basis of the correlation.

Namely, the method of producing a magnetoresistance effect element, which includes a magnetization fixing layer, a barrier layer formed on the magnetization fixing layer and a free layer formed on the barrier layer, comprises the steps of: forming the magnetization fixing layer on a substrate; forming a metal film as the barrier layer, wherein one part of the metal film on the magnetization fixing layer side is made of an amorphous or a refined crystalline substance and the other part thereof on the other side is made of a crystalline substance; natural-oxidizing the metal film in an oxidizing atmosphere; forming the free layer on the oxidized metal layer.

With this method, the one part of the metal film on the magnetization fixing layer side is formed in the amorphous state or the refined crystal state and the other part thereof on the other side is formed in the crystal state. The oxidization of the metal film proceeds from grain boundaries, and the one part of the metal film includes no grain boundaries or the refined crystals, so that the oxidization uniformly proceeds. Unlike the conventional method, the oxidization does not proceed along grain boundaries extending a layering direction until reaching the magnetization fixing layer, and the oxidization of the barrier layer can be easily stopped short of the magnetization fixing layer. Namely, the one part of the metal film can be oxidized without oxidizing the magnetization fixing layer.

In the method, a film forming rate of the one part of the metal film may be lower than that of the other part thereof, in the metal film forming step, so as to make crystal grains in the one part smaller than those in the other part. With this method, the amorphous substance or the refined crystalline substance can be formed with lowering the film forming rate.

In the method, the metal film may be formed by sputtering in the metal film forming step, and an electric power applied to the substrate for forming the one part of the metal film may be smaller than that for forming the other part thereof so as to make the film forming rate of the one part of the metal film lower.

In the method, the electric power for forming the one part of the metal film may be 1-3 W/cm², and the electric power for forming the other part thereof may be 5-10 w/cm².

In the method, a thickness of the one part of the metal film may be 30-50% of a thickness of the metal film.

On the other hand, the magnetoresistance effect element of the present invention includes: a magnetization fixing layer; a barrier layer formed on the magnetization fixing layer; and a free layer formed on the barrier layer, and is characterized in that the barrier layer is an oxidized metal film, in which one part of the metal film on the magnetization fixing layer side is made of an amorphous or a refined crystalline substance and the other part thereof on the other side is made of a crystalline substance.

With this structure, the one part of the metal film on the magnetization fixing layer side is made of the amorphous or the refined crystalline substance and the other part thereof on the other side is made of the crystalline substance. The oxidization of the metal film proceeds from grain boundaries, and the one part of the metal film includes no grain boundaries or the refined crystals, so that the oxidization uniformly proceeds. Unlike the conventional method, the oxidization does not proceed along grain boundaries extending a layering direction until reaching the magnetization fixing layer in a production process, and the oxidization of the barrier layer can be easily stopped short of the magnetization fixing layer. Namely, the one part of the metal film can be oxidized without oxidizing the magnetization fixing layer in the production process.

In the element, 30-50% of a thickness of the barrier layer may be constituted by oxidized amorphous or oxidized refined crystals.

By employing the method of the present invention, the oxidization of the magnetization fixing layer formed under the metal film, which acts as the barrier layer, can be highly restrained when the metal film is natural-oxidized. Therefore, deterioration of magnetic characteristics of the magnetization fixing layer can be highly restrained, and reading characteristics of the element can be stabilized.

### BRIEF DESCRIPTION OF THE DRAWINGS

Embodiments of the present invention will now be described by way of examples and with reference to the accompanying drawings, in which:

FIGS. 1A-1C are explanation views showing production steps of a magnetoresistance effect element of an embodiment of the present invention;

FIG. 2 is an explanation view of a crystal structure of a metal film formed by the method of the embodiment;

FIG. 3 is a graph of MR ratios of magnetization fixing layers (second explanation magnetization fixing layers) formed by the method of the embodiment and the conventional method;

FIG. 4 is a sectional view of the conventional magnetoresistance effect element;

FIGS. 5A-5C are explanation views showing production steps of the conventional magnetoresistance effect element; and

FIG. 6 is an explanation view of a crystal structure of a metal film formed by the conventional method.

### DETAILED DESCRIPTION OF THE EMBODIMENTS

Preferred embodiments of the present invention will now be described in detail with reference to the accompanying drawings.

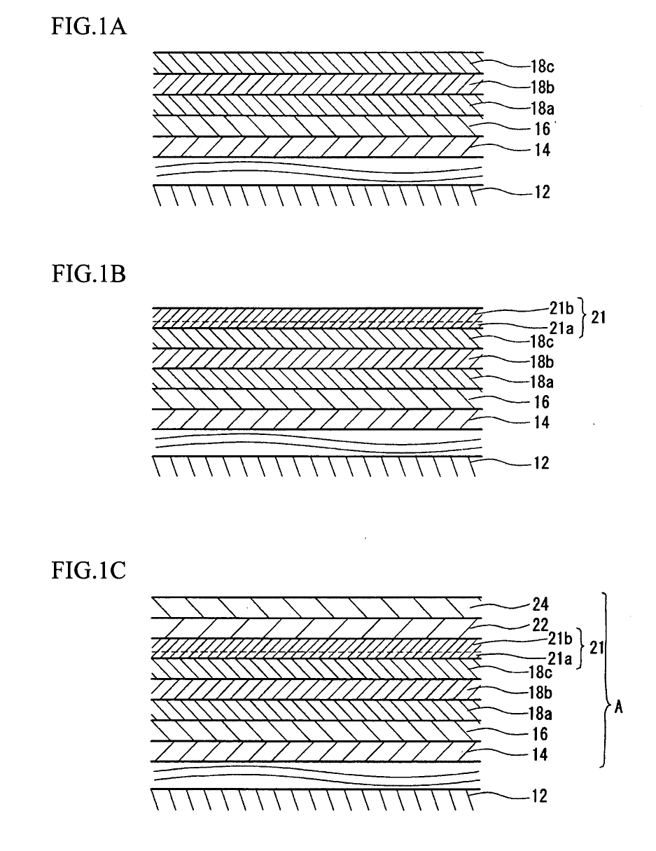

A method of producing a magnetoresistance effect element of the present embodiment will be explained with reference to FIGS. 1A-1C.

In FIG. 1A, firstly, a base layer 14 is formed on a wafer substrate 12. Next, an antiferromagnetic layer 16, a first magnetization fixing layer 18a, a ruthenium (Ru) layer 18b and a second magnetization fixing layer 18c are formed on the base layer 14 in this order. The first magnetization fixing layer 18a, the ruthenium (Ru) layer 18b and the second magnetization fixing layer 18c are called as a pinned layer. The first magnetization fixing layer 18a and the second magnetization fixing layer 18c are made of a ferromagnetic material, e.g., Co—Fe alloy.

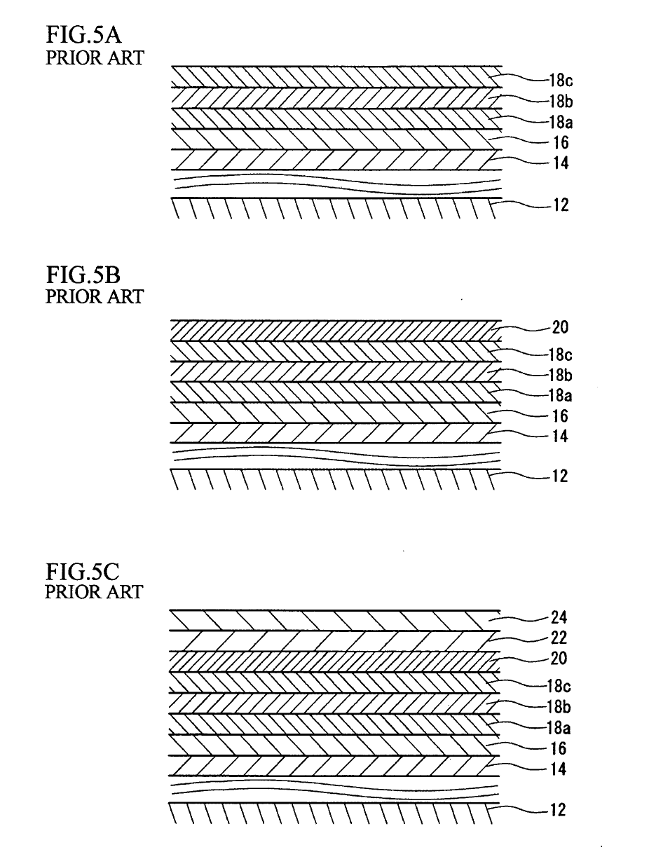

In FIG. 5B, a metal film 21, e.g., aluminum film, is formed on the second magnetization fixing layer 18c by sputtering. A thickness of the metal film 21 is about 5 Å.

A lower part 21a of the metal film 21, which is formed on the second magnetization fixing layer 18c side, is formed with a thickness of 1.5-2.5 Å, which is 30-50% of a total thickness of the metal film 21. The lower part 21a is made of an amorphous substance or a refined crystalline substance. On the other hand, an upper part 21b of the metal film 21, which is formed on the free layer side, is formed with a thickness of 2.5-3.5 Å. The upper part 21b is made of a crystalline substance.

Concretely, when the metal film 21 is formed, a film forming rate of the lower part 21a of the metal film 21 is lower than that of the upper part 21b thereof or the lower part 21a is formed slower than the upper part 21b, so that crystal grains in the lower part 21 are made smaller than those in the other part 21b.

More precisely, when the metal film 21 is formed by sputtering, an electric power applied to the substrate 12 for forming the lower part 21a of the metal film 21 is smaller, so that the film forming rate of the lower part 21a can be lower or slower. On the other hand, when the upper part 21b of the metal film 21 is formed, the electric power applied to the substrate 12 is increased so as to increase the film forming rate or form the upper part 21b faster.

Preferably, the electric power applied to the substrate 12 for forming the lower part 21a of the metal film 21 is 1-3 W/cm², so that the lower part 21a is made of the amorphous substance or the refined crystalline substance. On the other hand, the electric power for forming the upper part 21b thereof is 5-10 w/cm², so that the upper part 21b is made of the crystalline substance.

The film forming rate for forming the lower part 21a and the upper part 21b of the metal film 21 may be changed in not only two stages but also three stages or more. For example, the film forming rate may be gradually increased toward the upper part 21a by changing the electric power in three stages or more. In this case, the electric power applied to the substrate 12 is continuously increased.

After forming the metal film 21, the substrate 12 is put into an oxygen atmosphere chamber so as to natural-oxidize the metal film 21. Note that, the oxygen atmosphere in the chamber is not limited. For example, a pressure is 70-1000 Pa, preferably about 130 Pa, and oxidation time is about 10-30 minutes.

By the oxidizing process, the metal film 21 becomes aluminum oxide (Al-Oxide or AlO).

The metal film 21 made of the Al-Oxide acts as the barrier layer (tunnel barrier layer).

By oxidizing the metal film 21, volume of the metal film is increased so that the metal film 21 is made thicker. For example, when the initial thickness of the metal film 21 is about 5 Å, the thickness of the oxidized metal film 21 made of Al-Oxide will be about 10 Å.

In FIG. 1C, a free layer 22 is formed on the barrier layer (oxidized metal film) 21, and a top coat layer 24 is formed on the free layer 22.

Namely, the magnetoresistance effect element (TMR element) “A”, which acts as a read-element, is constituted by the base layer 14, the antiferromagnetic layer 16, the first magnetization fixing layer 18a, the ruthenium (Ru) layer 18b, the second magnetization fixing layer 18c, the barrier layer 21, the free layer 22 and the top coat layer 24.

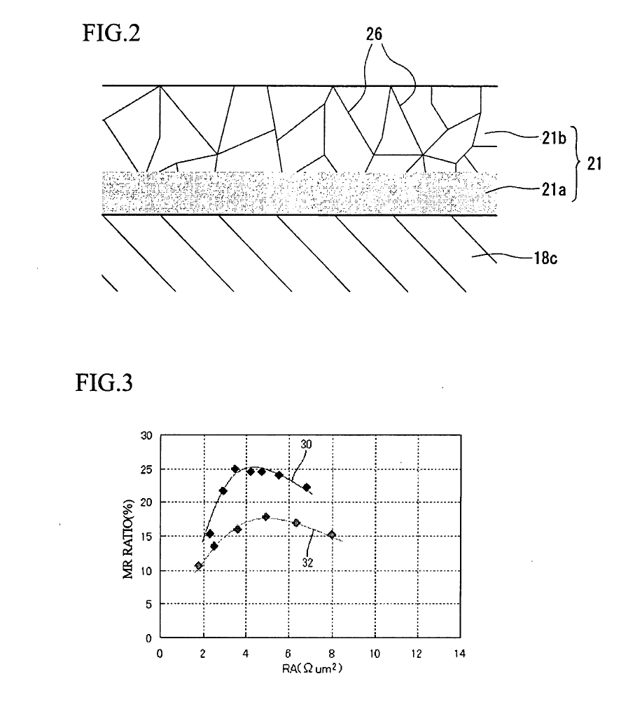

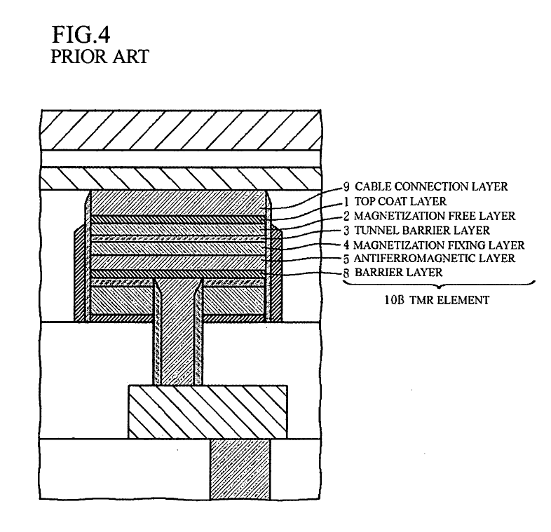

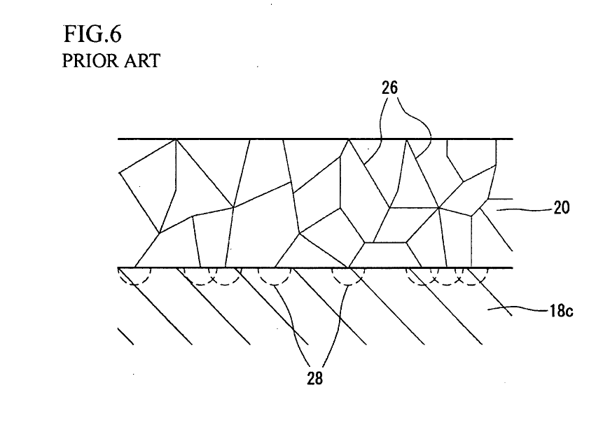

FIG. 2 is an explanation view of a crystal structure of the metal film 21 formed by the method of the present embodiment. On the other hand, FIG. 6 is an explanation view of a crystal structure of the metal film 20 formed by the conventional method. In FIGS. 2 and 6, lines 20, 21 and 26 stand for crystal grain boundaries.

In the conventional magnetoresistance effect element shown in FIG. 6, the oxidization firstly proceeds from the grain boundaries 26 in the natural oxidization process. In another word, the oxidization firstly proceeds along the grain boundaries 26 extending in the layering direction until reaching the part of the metal film 20 bordering the second magnetization fixing layer 18c. The oxidization reaches parts 28 (see FIG. 6) in the second magnetization fixing layer 18c early, so that oxidization of the second magnetization fixing layer 18c begins before the metal film 20 is entirely oxidized.

If the oxidization process is stopped before the oxidization reaches the second magnetization fixing layer 18c so as to prevent the oxidization of the second magnetization fixing layer 18c, the metal film 20 cannot be fully magnetized.

On the other hand, in the metal film 21 of the present embodiment shown in FIG. 2, the lower part 21a of the metal film 21 is made of the amorphous substance or the refined crystalline substance, so no grain boundaries are included or the refined crystals are included in the part 21a. Therefore, the oxidization uniformly proceeds from the upper part to the lower part, so that the entire metal film 21 can be oxidized until short of the second magnetization fixing layer 18c without oxidizing the second magnetization fixing layer 18c.

With this structure, deterioration of magnetic characteristics of the magnetization fixing layer can be highly prevented, and reading characteristics of the magnetoresistance effect element A can be stabilized.

Note that, the material of the metal film 21 is not limited to aluminum. One substance selected from titanium, magnesium, hafnium, thallium and tantalum may be employed. Namely, the barrier layer 21 is made of oxidized aluminum, titanium, magnesium, hafnium, thallium or tantalum.

The inventors measured MR ratios of the second magnetization fixing layer 18c, which are formed by the method of the present embodiment and the conventional method, after oxidizing the metal films 20 and 21.

Note that, the base layers 14, the ferromagnetic layers 16, the first magnetization fixing layer 18a, the ruthenium (Ru) layers 18b, the second magnetization fixing layer 18c, the free layer 22 and the top coat layers 24 of the experiment were the same as those of the above described embodiment, so explanation will be omitted.

In the conventional method, the metal film 20 was formed by sputtering aluminum with applying fixed electric power (7.3452 W/cm²) to the substrate 12, so that the metal film 20 was formed on the second magnetization fixing layer 18c. A film forming rate of the metal film 20 was fixed rate, and the metal film 20 was made of a crystalline substance.

In an actual production process, the sputtering is performed with rotating the substrate 12 so as to uniformly form the metal film 20. However, in the experiment, the substrate 12 was fixed and inclined with respect to an electric discharging direction of the sputtering so as to measure MR ratios of various film thicknesses. Therefore, the surface of the metal film 20 was inclined with respect to the surface of the second magnetization fixing layer 18c. Namely, the thickness of the metal film 20 was continuously varied.

On the other hand, in the method of the above described embodiment, the lower part 21a of the metal film 21 was firstly formed by sputtering aluminum with applying electric power of 1.9716 W/cm² to the substrate 12, so that the lower part 21a was formed on the second magnetization fixing layer 18c. Next, the upper part 21b of the metal film 21 was formed by sputtering aluminum with applying electric power of 7.3452 W/cm² to the substrate 12, so that the upper part 21b of the metal film 21 was formed on the lower part 21a thereof.

The unit electric power for forming the lower part 21a of the metal film 21 was very small, so the film forming rate was very low or slow. Therefore, aluminum film in the part 21a was formed in the state of amorphous or refined crystals. On the other hand, the unit electric power for forming the upper part 21b of the metal film 21 was greater, so the film forming rate was high or early as well as the conventional method. Therefore, aluminum film in the part 21b was crystallized.

In the method of the above described embodiment too, the substrate 12 was fixed and inclined with respect to the electric discharging direction of the sputtering so as to incline the surface of the metal film 20 and continuously vary the thickness of the metal film 21.

Note that, sputtering conditions, e.g., time periods of sputtering processes for forming the parts 21a and 21b, were designed so as to form the lower part 21a of the metal film 21 made of the amorphous substance or the refined crystalline substance, whose thickness was about 30% of the total thickness of the metal film 21.

After forming the metal films 20 and 21 by the conventional method and the method of the above described embodiment, the substrates 12 were respectively put into the oxygen atmosphere chambers so as to natural-oxidize the metal films 20 and 21 and form the barrier layers. Pressure of the oxygen atmosphere was 130 Pa, and time of oxidizing process was 10 minutes.

After the oxidizing process, MR ratios of the second magnetization fixing layers 18c of the both samples were measured. The results are shown in FIG. 3.

A horizontal axis of a graph in FIG. 3 indicates RA values (electric resistivity per one square micron) of the second magnetization fixing layers 18c. Note that, the RA value is varied by the thicknesses of the barrier layers 20 and 21. On the other hand, a vertical axis of the graph indicates MR ratios of the second magnetization fixing layers 18c corresponding to the RA values. In FIG. 3, a curved line 30 indicates the sample with the barrier layer 21 formed by the method of the above described embodiment; a curved line 32 indicates the sample with the barrier layer 20 formed by the conventional method.

According to FIG. 3, the MR ratios of the sample having the barrier layer 21 were higher than those of the sample having the barrier layer 20, with respect to all of the measured RA values (the thicknesses of the barrier layers 20 and 21).

As described above, in the magnetoresistance effect element A of the present embodiment, the oxidization of the second magnetization fixing layer 18c can be prevented, so that magnetic characteristics, e.g., MR ratio, of the second magnetization fixing layer 18c can be improved and reading characteristics of the magnetoresistance effect element A can be improved.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a magnetoresistance effect element, which includes a magnetization fixing layer, a barrier layer formed on the magnetization fixing layer and a free layer formed on the barrier layer,
comprising the steps of:
forming the magnetization fixing layer on a substrate;
forming a metal film as the barrier layer, wherein one part of the metal film on the magnetization fixing layer side is made of an amorphous or a refined crystalline substance and the other part thereof on the other side is made of a crystalline substance;
natural-oxidizing the metal film in an oxidizing atmosphere;
forming the free layer on the oxidized metal layer.

2. The method according to claim 1,
wherein a film forming rate of the one part of the metal film is lower than that of the other part thereof, in said metal film forming step, so as to make crystal grains in the one part smaller than those in the other part.

3. The method according to claim 2,
wherein the metal film is formed by sputtering in said metal film forming step, and
an electric power applied to the substrate for forming the one part of the metal film is smaller than that for forming the other part thereof so as to make the film forming rate of the one part of the metal film lower.

4. The method according to claim 3,
wherein the electric power for forming the one part of the metal film is 1-3 W/cm², and
the electric power for forming the other part thereof is 5-10 w/cm².

5. The method according to claim 1,
wherein a thickness of the one part of the metal film is 30-50% of a thickness of the metal film.

6. A magnetoresistance effect element including: a magnetization fixing layer; a barrier layer formed on the magnetization fixing layer; and a free layer formed on the barrier layer,
wherein the barrier layer is an oxidized metal film, in which one part of the metal film on the magnetization fixing layer side is made of an amorphous or a refined crystalline substance and the other part thereof on the other side is in a crystalline substance.

7. The magnetoresistance effect element according to claim 6,
wherein 30-50% of a thickness of the barrier layer is constituted by the oxidized amorphous or oxidized refined crystalline substances.
